(19) United States
(12) Patent Application Publication
(10) Pub. No.: US 2026/0056944 A1
(43) Pub. Date: Feb. 26, 2026

(54) HYBRID STORAGE OF REGISTER INFORMATION FOR AN INTEGRATED CIRCUIT

(71) Applicant: Microsoft Technology Licensing, LLC, Redmond, WA (US)

(72) Inventors: Dibyendu DEY, Portland, OR (US); Vanila CHINTHA REDDY, Portland, OR (US); Jarred Joseph WHITE, Portland, OR (US); Dong Hyun BAIK, Portland, OR (US); Charles Parker WOOD, Portland, OR (US); Samuel Chelsae KNIGHT, Portland, OR (US)

(21) Appl. No.: 18/811,521

(22) Filed: Aug. 21, 2024

(51) Int. Cl. G06F 16/245; G06F 16/27

(52) U.S. Cl. CPC G06F 16/245; G06F 16/27

(57) ABSTRACT

Embodiments of the present disclosure include a method of storing information about registers in an integrated circuit. In one embodiment, registers from an integrated circuit have corresponding structured and unstructured information describing the registers. In one embodiment, validation software stores the structured information in one database and stores the unstructured information in another database. The structured information may be stored in a high-speed local database, and the unstructured information may be stored in a cloud computing environment database with access to cloud software services. For each register, structured information in the local database may be linked to structured information in the cloud database using a unique ID.

### BACKGROUND

The present disclosure relates generally to semiconductor integrated circuits, and in particular, to hybrid storage of register information for an integrated circuit.

Modern semiconductor integrated circuits (ICs) can contain many thousands, hundreds of thousands, or millions of registers. A register is a circuit that stores digital data (e.g., zeros and ones represented as voltages). Registers are used for a wide range of purposes and may be found throughout an IC. For example, CPUs, memories, I/O controllers and many other subsystems of a digital IC may contain many registers.

Verifying the functionality of large volumes of registers can be challenging. Data associated with the registers can become voluminous. Finding particular registers and information about the registers can be time consuming and slow. When register information is changed in the HDL, propagating such information accurately to verification scripts can be tedious and difficult.

The present disclosure is directed to systems and methods to improve storage and retrieval of information about registers in an integrated circuit, such as an SoC, for example.

### BRIEF DESCRIPTION OF THE DRAWINGS

FIG. 1 illustrates a system according to an embodiment.

FIG. 2 illustrates a method according to an embodiment.

FIG. 3 illustrates an example system for validation of an integrated circuit according to an embodiment.

FIG. 4 illustrates an example method for validation of an integrated circuit according to an embodiment.

FIG. 5 illustrates an example method for generating structured and unstructured data for registers in an integrated circuit according to an embodiment.

### DETAILED DESCRIPTION

Described herein are techniques for storing information about registers in integrated circuits. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

Various implementations of the present disclosure may be used for either pre-silicon verification or post-silicon validation. Various embodiments and examples illustrated below refer to validation, but it is to be understood that the present disclosure is also applicable to verification.

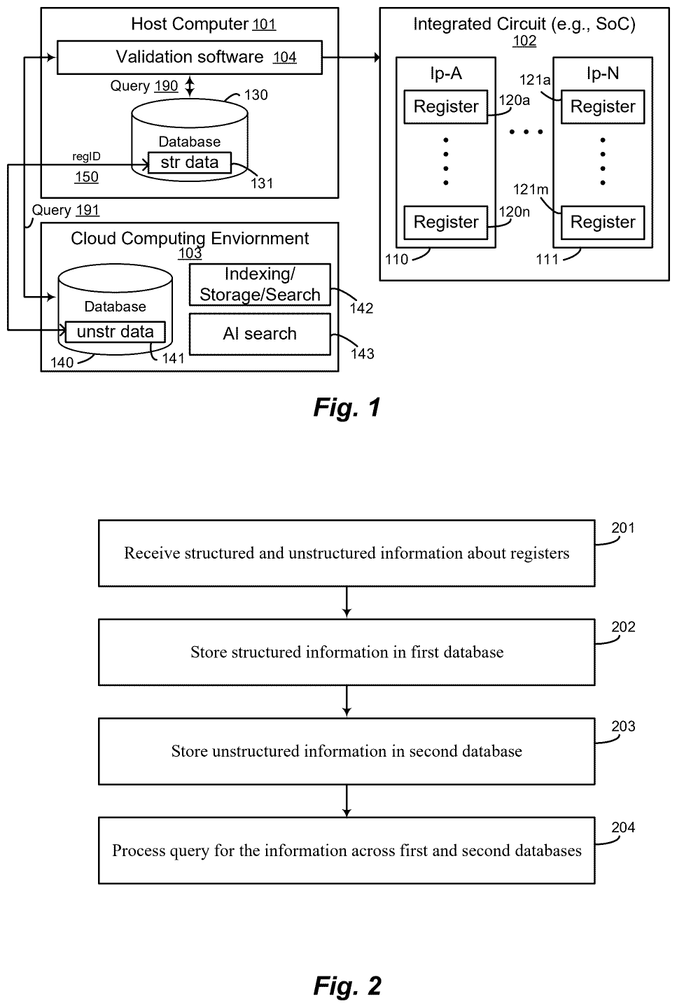

FIG. 1 illustrates a circuit according to an embodiment. Features and advantages of the present disclosure include techniques for storing information about registers in integrated circuits that may contain many registers (e.g., on the order of hundreds of thousands or even millions). Some embodiments may include information about each register. Information about a register may include information that describes the register, such as information describing or specifying attributes of the register. Such information may include structured information and unstructured information. Structured information about a register may include an address, name, size, or access type, for example. Unstructured information about a register may include a description associated with the register, such as a text description of what the register does, where it is used, why it is used, current or past register status, or just about any other textual information that may be useful for a user, for example. In some situations, unstructured information may comprise up to 70% of the total data storage required to store both structured and unstructured information for an integrated circuit design (e.g., a system-on-a-chip, SoC). Advantageously, structured information may be stored in one database and unstructured information may be stored in another database. In certain embodiments, the structured information is stored in a high speed database optimized for key-value pairs, while the unstructured information is stored in a cloud computing environment database where resources are available for analysis and retrieval of unstructured data, for example.

Certain embodiments of the systems and methods disclosed herein are illustrated in FIG. 1, which includes a host computer 101, integrated circuit (IC) 102, and cloud computing environment 103. Host computer 101 may be any of a wide range of computer architectures, which typically comprise one or more processors (CPUs) and memory (RAM, DRAM, persistent drives, etc.) configured to execute instructions (e.g., computer software) to perform various functions and operations. Here, host computer 101 is configured to run validation software 104, which interacts with IC 102 to verify the functionality of an IC design (e.g., an SoC). During design of an IC, IC 102 may be embodied in a hardware definition language (HDL) created by IC designers and executed in an emulation environment, such as an emulation components of an electronic design automation (EDA) software system from Synopsys, Cadence, or Mentor Graphics/Siemens, for example. In other embodiments, IC 102 may be a physical circuit Validation software 104 may access certain registers of the IC 102 during pre-silicon verification of a design or during post silicon validation of an actual physical IC. In modern System on Chips (SoCs), the presence of millions of registers can result in tens of gigabytes of information. This makes quick retrieval of data for validation and verification purposes a challenging task. The hybrid approach of storing structured information locally and unstructured information in the cloud offers several advantages: it enables rapid data retrieval, reduces local storage requirements, and allows for the utilization of cloud-based features on the retrieved data. Accordingly, it is to be understood that IC 102 may be embodied as an integrated circuit represented as a hardware description language (HDL) running in a circuit emulation environment, in some embodiments, or as a physical circuit, in other embodiments, for example.

Validation software 104 may use the techniques described herein for managing and accessing data about each register in IC 102 (e.g., during development of validation scripts or debug). Here, IC 102 includes a plurality of subsystems, commonly referred to as intellectual properties (“Ip”). For example, IC 102 includes Ip-A 110 to Ip-N 111, each of which are hardware circuits (typically digital circuits). Each Ip includes numerous registers, such as registers 120a-n in Ip-A 110 and registers 121a-m in Ip-N 111. Different Ips may correspond to different top level elements (or system components) of the IC 102, such as processors (CPUs), memory, I/O controllers, or a variety of other functional blocks. As described in more detail below, different Ips may have hierarchies of subsystems that each comprise numerous registers, for example.

To access registers on IC 102, validation system 104 may use a mechanism for storing information about the registers. In various embodiments, information about registers 120a-n and 121a-m is received in validation software 104 and structured information (e.g., “str data”) 131 about registers 120a-n and 121a-m is stored database 130, whereas unstructured information (e.g., “unstr data”) 141 about registers 120a-n and 121a-m is stored database 140. In some embodiments, database 130 may be a database configured to store key-value pairs, for example, which may be a local database optimized for high-speed retrieval of the structured information about the registers. Database 140 resides in a cloud computing environment 103, and thus, validation software 104 running on host computer 101 may interface with database 140 over a network, such as the Internet, for example. Cloud database 140 may have access to more storage resources (e.g., cloud storage) as well as access to cloud software services, such as analytic and/or search software for indexing, storing, and searching 142 or artificial intelligence searching 143 of unstructured data 141. Example cloud computing environments include Amazon Web Services (AWS), Azure, and Google Cloud, for example.

For example, as described in more detail below, the structured information 131 and unstructured information 141 comprise data elements associated with each register 120a-n and 121a-m describing each particular register. Embodiments of the present disclosure may include storing a unique identification (ID) 150 with each structured and unstructured data element corresponding to the same register to link data elements for particular registers between database 131 and 141. In some embodiments described further below, unique ID 150 (aka, register ID or “regID”) comprises a string corresponding to a location of a particular register in the integrated circuit. For example, an ID string may specify a hierarchical location of each register in a plurality of nested integrated circuit subcircuits.

Validation software 104 may be used to generate queries to databases 130 or 140. For example, a first query 190 may be sent to database 130 to retrieve the structured information 131 and a second query 191 may be sent to database 140 to retrieve the unstructured information 141. In one embodiment, a query 191 is sent to database 141, and query 191 retrieves at least one unstructured data element for at least one register from database 140. The unique ID is then used (e.g., in query 190) to retrieve at least one structured data element for the at least one register from database 130, for example. Accordingly, validation software 104 may seamlessly access information about any particular register from a multitude of registers in IC 102 using either structured information about the register or using unstructured information about the register (e.g., a text description). Advantageously, query 191 may not be required to be an exact match with the unstructured data stored in database 140 to retrieve data. In some embodiments, query 191 may be used in an AI search (e.g., a similarity search) where query 191 includes information “close” to a particular unstructured data element (e.g., a portion of a description that may include different spellings or similar combinations of characters). AI search 143 may be used, for example, to retrieve unstructured data 141 that is “likely”to be the correct result, for example.

FIG. 2 illustrates a method according to an embodiment. At 201, structured and unstructured information about registers of an IC are received (e.g., in a validation software system). At 202, structured information is stored in a first database. The first database may be a local database storing key-values, for example. At 203, unstructured information is stored in a second database. The second database may be a cloud database with access to cloud software services, for example. Steps 202 and 203 may occur in any order in various embodiments. At 204, a query is processed to retrieve the information. A first query may be used to retrieve structured data from the first database, and a second query may be used to retrieve unstructured data from the second database. In some embodiments, structured data and unstructured data for the same register are linked using a unique ID. The unique ID is stored with the structured data in the first database and the unique ID is stored with the unstructured data in the second database. Accordingly, accessing a record with register information in either database provides the unique ID to access a corresponding record for register information in the other database.

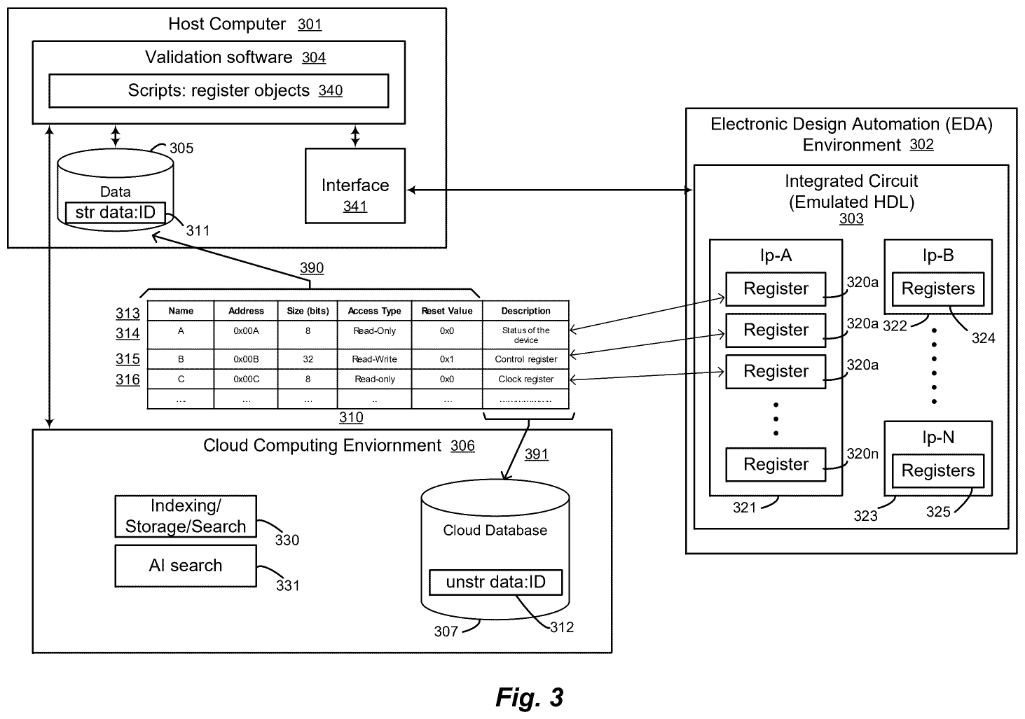

FIG. 3 illustrates an example validation system according to an embodiment. In this example, a host computer 301 runs validation software 304 to verify an integrated circuit 303 in an electronic design automation (EDA) environment 302. In various embodiments, portions of EDA 302 may run on host computer 301 and/or remote server computers, for example. Integrated circuit 303 may be embodied in HDL and emulated by EDA 302, for example. Integrated circuit 303 includes a plurality of component systems (Ips) 321-323.

Each Ip 321-323 includes potentially many registers, such as registers 320a-n in Ip-A 321, registers 324 in Ip-B 322, and registers 325 in Ip-N 323. Host computer 301 may communicate with IC 303 running in development environment 302 using interface 341, which may be a JTAG interface, for example.

Features and advantages of the present disclosure may include scanning the HDL for register information and storing the structured information 311 for each register in database 305 and storing unstructured information 312 in a cloud database 307 in cloud computing environment 306. Validation software 304 may receive the HDL representation of the integrated circuit 303 and traverse through the HDL to find registers 320a-n, 322, and 323. In some embodiments described further below, the registers may be located in a plurality of nested subsystems of the integrated circuit. For example, Ip-A 321 may be a CPU having a control unit subsystem, which may have one or more subsystems that include a portion of registers 320a-n, for example. Validation software 304 may extract structured data and unstructured data for each register from the HDL code. Table 310 illustrates structured and unstructured data that may be extracted from HDL. Registers may have a plurality of attributes 313, such as name, address, size (bits), access type (e.g., read-only, read-write, etc.), a reset value, and description (text). Other example structured data may comprise key-value pairs for: source filename, relative address, array definition, read mask, has reset value, write mask, etc. The data associated with each register may be stored as rows of table 310, where each row 314-316 stores data associated with each particular register in IC 303. However, rather than storing the data in a single table, structured data elements 390 are stored in database 303 and unstructured data elements 391 are stored in cloud database 307. Additionally, validation software 304 may generate a unique ID for each register and store the unique ID for each register with the register's structured and unstructured data, as illustrated at 311 and 312. In some embodiments, the ID may specify a location of the register in the nested subsystems mentioned above, for example.

In some embodiments, database 305 may be a local database optimized for speed, such as an embedded transactional key-value store database running on local computer 301. Database 305 may be a light memory-mapped database (LMDB), for example. Cloud database 307 may run in cloud computing environment 306 with access to various cloud software services such as indexing, storage, search 330 or AI search 331.

In certain embodiments, users may create scripts 340 for verifying the IC. The scripts 340 may be written in an object-oriented language, for example, where registers are represented as objects (register objects), creation of which may require structured information, for example. During validation, a user may want to determine information about particular registers, such as when troubleshooting a particular register, the user may want to retrieve the status description of the register, which may be stored as unstructured information, for example. Accordingly, when a register is used for validation, a user may occasionally access unstructured information (during debug), but structured information may be required more frequently (during creation and debug of register objects), for example. As mentioned above, a user may want to obtain information about a register during debug, but may want to access the information qualitatively without having to lookup the register's address or structured information every time. Advantageously, a user may enter an unstructured search and use the cloud software services to search for particular registers, rather than by a particular address, which may be burdensome in an environment with hundreds of thousands or even millions of registers, for example.

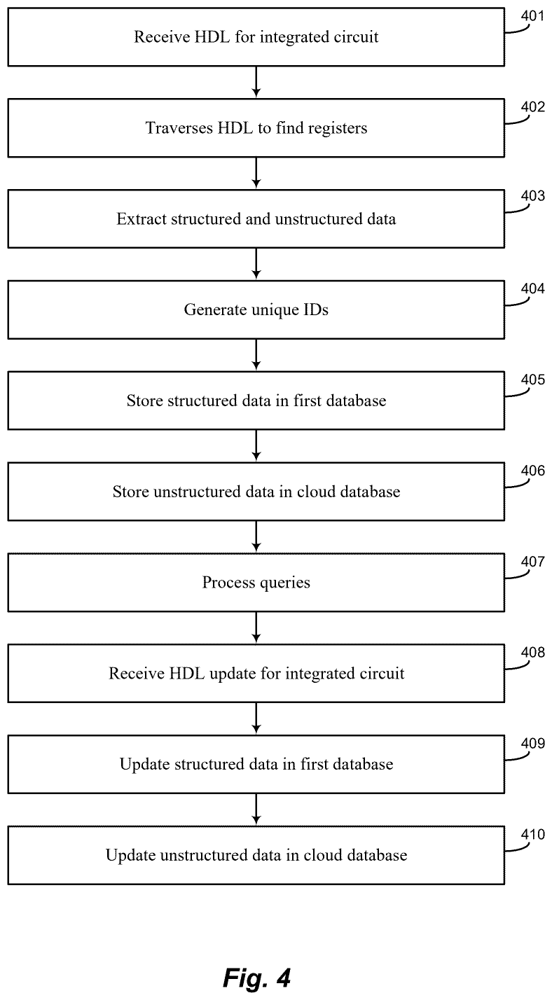

FIG. 4 illustrates an example method according to an embodiment. At 401, HDL for an IC is received in a validation software system. At 402 the software traverses (or parses) the HDL to find registers and related register data. At 403, structured and unstructured data is extracted from the HDL. At 404, unique IDs are generated and associated with each structured/unstructured data element for each register. At 405, the structured data is stored in a first database, and the unstructured data is stored in a cloud database at 406. It is to be understood that steps 401-406 may be performed in different orders in various embodiments.

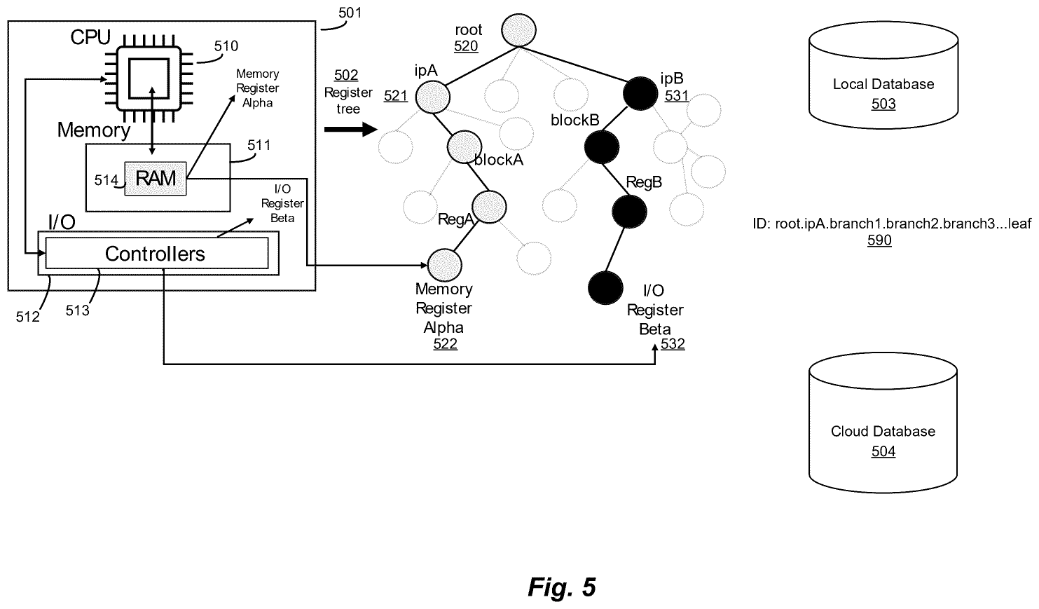

FIG. 5 illustrates an example technique for generating IDs according to an embodiment. In FIG. 5, an IC 501 includes a CPU 510, memory 511, and I/O interface 512. Memory 511 may include RAM 514, which may be partitioned into blocks with registers located in different blocks, for example. Circuit blocks within other circuit blocks within an Ip are referred to as nested subsystems. Similarly, I/O 512 may include one or more controllers 513, each including one or more subsystems including other particular registers. In one embodiment, validation software generates a register tree 502. Register tree 502 may comprise a root node 520 corresponding to the IC, first level sub-nodes (e.g., node 521 for memory 511 and node 531 for I/O 512) coupled to the root node. Each successive nested subsystem within memory 511 is represented by a node branching off of node 521 until the final subsystem is reached containing memory register alpha 522. Similarly, each successive nested subsystem within I/O 512 is represented by a node branching off of node 531 until the final subsystem is reached containing I/O register beta 532. The nodes may correspond to a hierarchical relation of each particular register within a IC design, for example. In this example, the ID generated for each register corresponds to the hierarchical relation of the register within the IC. In particular, an ID may be generated comprising a string corresponding to a hierarchical relation of a particular register in the IC. The ID may be derived from a path from root 520 to the particular register, for example, to specify the hierarchical relation in the nested subsystems. As illustrated at 590, an ID may be of the form “root.ipA.node1,node2.node3 . . . leaf”, where the leaf is the register and the nodes are the nested subsystems (e.g., abbreviations for each subsystem). Thus, ID string may specify a hierarchical location of a particular register in a plurality of nested integrated circuit subcircuits, for example. Once the ID is generated, the ID may be associated with the structured data and unstructured data and stored in local database 503 and cloud database 504, respectively.

Referring again to FIG. 5, queries may be received and processed at 407. For example, a user may enter a query for structured data into the local database and obtain a fast result, or a user may perform an AI query to the cloud database, which may return unstructured and structured information using the ID to link and retrieve both structured and unstructured data, for example.

Advantageously, embodiments of the present disclosure may result in very efficient updates. For example, if an IC design is changed and updated HDL is released at 408, the software may parse the new HDL and update the structured data in the first database at 409 (e.g., if register addresses have changed or if registers have been deleted, moved, or added). Similarly, unstructured data may be updated in the cloud database at 410, for example. At both 409 and 410, the IDs may be updated automatically to link structured data in one database with unstructured data in the other database, for example.

### FURTHER EXAMPLES

Each of the following non-limiting features in the following examples may stand on its own or may be combined in various permutations or combinations with one or more of the other features in the examples below. Embodiments of the present disclosure may include systems, methods. Some embodiments of the present disclosure may be performed in software executing on a computer system comprising at least one processor and at least one computer readable medium, such as memory, which stores instructions, executed by the processor, to perform methods according to various embodiments disclosed herein.

In one embodiment, the present disclosure includes a method comprising: receiving information about a plurality of registers of an integrated circuit, the information comprising structured information and unstructured information; storing the structured information in a first database; storing the unstructured information in a second database; and processing at least one query, wherein a first query is sent to the first database to retrieve the structured information and a second query is sent to the second database to retrieve the unstructured information.

In one embodiment, the structured information and unstructured information comprises data elements associated with each register of the plurality of registers, the data elements describing each particular register.

In one embodiment, data elements for the structured information and data elements for the unstructured information each comprise a unique identification to link data elements for particular registers between the first database and the second database.

In one embodiment, the second query is sent to the second database, and wherein the second query retrieves at least one unstructured data element for at least one register from the second database, and wherein the unique identification is used in the first query to retrieve at least one structured data element for the at least one register from the first database.

In one embodiment, the unique identification comprises a string corresponding to a hierarchical relation of a particular register in the integrated circuit.

In one embodiment, the string specifies a hierarchical location of the particular register in a plurality of nested integrated circuit subcircuits.

In one embodiment, the first database is a local database and the second database is a cloud computing environment database, wherein queries to the cloud computing environment database are processed using cloud software services.

In one embodiment, the cloud software services comprise an indexed search of the unstructured information.

In one embodiment, the cloud software services comprise an artificial intelligence (AI) search.

In one embodiment, the local database is an embedded transactional key-value store database running on a local computer.

In one embodiment, the structured information comprises, for the plurality of registers, a register address, a register name, a size, an access type, and a reset value.

In one embodiment, the unstructured information comprises, for the plurality of registers, a text description.

In one embodiment, the integrated circuit comprises one or more processors, one or more memories, and one or more input-output (I/O) circuits.

In one embodiment, the method further comprises receiving an update of a hardware description language for the integrated circuit, the update changing structured information for at least one register of the plurality of registers; updating the first database with the changed structured information and one or more modified unique identifications; and updating the second database with one or more modified unique identifications.

In one embodiment, the method is performed by a software system executing on a local computer configured with the first database, the method further comprising: receiving, by the software system, a hardware description language (HDL) representation of the integrated circuit; traversing through the HDL to find the plurality of registers in a plurality of nested subsystems of the integrated circuit; extracting, for each register of the plurality of registers, structured data and unstructured data; and generating a unique identification for each register specifying a location in the nested subsystems, wherein said step of storing the structured information in the first database further comprises storing the unique identification for each register with corresponding structured information for each register, and wherein said step of storing the unstructured information in the second database further comprises storing the unique identification for each register with corresponding unstructured information for each register.

In one embodiment, the integrated circuit is represented as a hardware description language running in a circuit emulation environment.

In one embodiment, the integrated circuit is a physical circuit.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
receiving information about a plurality of registers of an integrated circuit, the information comprising structured information and unstructured information;
storing the structured information in a first database;
storing the unstructured information in a second database; and
processing at least one query, wherein a first query is sent to the first database to retrieve the structured information and a second query is sent to the second database to retrieve the unstructured information.

2. The method of claim 1, wherein the structured information and unstructured information comprises data elements associated with each register of the plurality of registers, the data elements describing each particular register.

3. The method of claim 2, wherein data elements for the structured information and data elements for the unstructured information each comprise a unique identification to link data elements for particular registers between the first database and the second database.

4. The method of claim 3, wherein the second query is sent to the second database, and wherein the second query retrieves at least one unstructured data element for at least one register from the second database, and wherein the unique identification is used in the first query to retrieve at least one structured data element for the at least one register from the first database.

5. The method of claim 3, wherein the unique identification comprises a string corresponding to a hierarchical relation of a particular register in the integrated circuit.

6. The method of claim 5, wherein the string specifies a hierarchical location of the particular register in a plurality of nested integrated circuit subcircuits.

7. The method of claim 1, wherein the first database is a local database and the second database is a cloud computing environment database, wherein queries to the cloud computing environment database are processed using cloud software services.

8. The method of claim 7, wherein the cloud software services comprise an indexed search of the unstructured information.

9. The method of claim 7, wherein the cloud software services comprise an artificial intelligence (AI) search.

10. The method of claim 7, wherein the local database is an embedded transactional key-value store database running on a local computer.

11. The method of claim 1, wherein the structured information comprises, for the plurality of registers, a register address, a register name, a size, an access type, and a reset value.

12. The method of claim 11, wherein the unstructured information comprises, for the plurality of registers, a text description.

13. The method of claim 1, wherein the integrated circuit comprises one or more processors, one or more memories, and one or more input-output (I/O) circuits.

14. The method of claim 1, further comprising:
receiving an update of a hardware description language for the integrated circuit, the update changing structured information for at least one register of the plurality of registers; and
updating the first database with the changed structured information and one or more modified unique identifications; and
updating the second database with one or more modified unique identifications.

15. The method of claim 13, wherein the method is performed by a software system executing on a local computer configured with the first database, the method further comprising:
receiving, by the software system, a hardware description language (HDL) representation of the integrated circuit;
traversing through the HDL to find the plurality of registers in a plurality of nested subsystems of the integrated circuit;
extracting, for each register of the plurality of registers, structured data and unstructured data; and
generating a unique identification for each register specifying a location in the nested subsystems,
wherein said step of storing the structured information in the first database further comprises storing the unique identification for each register with corresponding structured information for each register, and
wherein said step of storing the unstructured information in the second database further comprises storing the unique identification for each register with corresponding unstructured information for each register.

16. The method of claim 1, wherein the integrated circuit is represented as a hardware description language running in a circuit emulation environment.

17. The method of claim 1, wherein the integrated circuit is a physical circuit.

18. A method comprising:
receiving, in a software system running on a first computer, information about a plurality of registers of a hardware description language representation of an integrated circuit running in a circuit emulation environment, the information comprising structured information and unstructured information for each register of the plurality of registers;
storing the structured information in a first database configured on the first computer;
storing the unstructured information in a cloud computing environment database,
wherein structured information for each particular register of the plurality of registers and unstructured information for each particular register of the plurality of registers comprise a same unique identification to link structured information and unstructured information for each register between the first database and the second database;
processing a query, wherein a first query is sent to the cloud computing environment database and processed using one or more cloud software services in the cloud computing enviroment, wherein the first query retrieves unstructured data for at least one register of the plurality of registers from the second database using the cloud software services, and wherein the unique identification is used in a second query to automatically retrieve structured data for the at least one register from the first database.

19. A computer system comprising:
at least one processor;
at least one memory storing instructions, executed by the processor, to perform a method comprising:
receiving information about a plurality of registers of an integrated circuit, the information comprising structured information and unstructured information;
storing the structured information in a first database, wherein structured information for each register of the plurality of registers is associated with a unique identification;
storing the unstructured information in a second database, wherein unstructured information for each register of the plurality of registers is associated with the unique identification; and
processing at least one query, wherein a first query is sent to the first database to retrieve the structured information and a second query is sent to the second database to retrieve the unstructured information.

20. The computer system of claim 19, wherein the structured information comprises, for the plurality of registers, a register address, a register name, a size, an access type, and a reset value and the unstructured information comprises, for the plurality of registers, a text description.
